(19) United States
(12) Patent Application Publication
(10) Pub. No.: US 2025/0258286 A1
(43) Pub. Date: Aug. 14, 2025

(54) SYSTEMS AND METHODS FOR CONSERVING POWER ON A MARINE ELECTRONIC DEVICE WHILE CONVEYING INFORMATION TO A USER

(71) Applicant: Navico Group Americas, LLC, Menomonee Falls, WI (US)

(72) Inventor: Christopher M. Strickland, Broken Arrow, OK (US)

(21) Appl. No.: 18/438,861

(22) Filed: Feb. 12, 2024

(51) Int. Cl. G01S 7/62; G01S 15/96; G06F 1/3296

(52) U.S. Cl. CPC G01S 7/6218; G01S 15/96; G06F 1/3296

(57) ABSTRACT

Example systems and methods are provided herein for conserving power on a marine electronic device while conveying information to a user. Some such systems include a marine electronic device configured to change to a power-saving mode, in which the marine electronic device operates by drawing a reduced amount of power from a power source and does not provide real-time marine data from the sonar transducer. A second device uses power from a second power source. The marine electronic device includes a processor that receives second device real-time marine data from the second device and causes presentation of a representation of the second device real-time marine data on a screen of the marine electronic device while still operating in the power-saving mode. The second device real-time marine data is gathered or determined via the second device.

### FIELD OF THE INVENTION

Example embodiments of the present invention generally relate to watercrafts and, more particularly to, systems and methods for conserving power on a marine electronic device while conveying information to a user.

### BACKGROUND

Watercraft often contain marine electronic devices that are connected to systems such as sonar transducers and provide real-time marine data to users through a screen on the marine electronic device. Such marine electronic devices often use significant amounts of power that can be wasteful in moments in which users on the watercraft do not need or are not using the information being displayed on the screen of the marine electronic device. Current solutions to this problem include marine electronic devices with power saving modes that either turn the marine electronic device off or make it “go to sleep” when certain thresholds are met (e.g., user interaction has not occurred in a predetermined amount of time). Such solutions are impractical for certain scenarios, however, in which information from the marine electronic device is suddenly needed in moments when there is insufficient time to transfer the marine electronic device back into a normal mode. For example, users on a boat may be waiting to catch a fish, and the marine electronic device(s) on the watercraft may go into a power saving mode that renders the screen black. In the instant that a fish bites on a line connected to the watercraft, the users are directed to the portion of the boat with the fish on the line and do not have time to click any buttons on the marine electronic device. However, the users may need information from the marine electronic device in that instant.

Improvements in the foregoing are desired.

### BRIEF SUMMARY

The current disclosure provides systems and methods that conserve power on a marine electronic device while still conveying information to a user. Such systems and methods include a marine electronic device capable of changing to a power-saving mode in which the marine electronic device operates by drawing a reduced amount of power from a power source and stops providing real-time marine data from, e.g., a sonar transducer. The marine electronic device is configured with a processor that receives real-time data from a different device (that utilizes its own power source) and causes presentation of such real-time data from the different device on a screen of the marine electronic device while the marine electronic device is operating in the power-saving mode.

This allows users to be able to glance at the marine electronic device while the marine electronic device is in the power-saving mode and gather certain information. For example, in a scenario in which users on a watercraft are waiting on a fish to bite on a line connected to the watercraft, and the marine electronic device on the watercraft is in the power-saving mode, when a fish does bite on the line, the users need not do anything except glance at the screen of the marine electronic device to gather information such as water temperature or water depth during the critical moment of the fish biting. This also allows for the marine electronic device to save power without sacrificing its utility on the watercraft. For example, instead of the users turning off a power-saving feature altogether in fear of not having information in critical moments, users may be more likely to use the power-saving mode knowing that information will still be available on the screen in critical moments.

Some example embodiments of the present invention include systems and methods for conserving power on a marine electronic device while conveying information to a user. Such systems and methods include a marine electronic device configured to operate to provide real-time marine data from a sonar transducer in a first mode, and the marine electronic device is further configured to be able to change to a power-saving mode in which the marine electronic device operates by drawing a reduced amount of power from a power source and does not provide real-time marine data from the sonar transducer. Such systems and methods also include a second device that uses a second amount of power from a second power source. A processor of the marine electronic device is configured to receive second device real-time marine data from the second device, and the second device real-time marine data is gathered or determined via the second device and not the marine electronic device. The processor is then configured to cause presentation of a representation of the second device real-time marine data on a screen of the marine electronic device while still operating in the power-saving mode.

In an example embodiment, a system is provided for conserving power on a marine electronic device while conveying information to a user. The system includes a sonar transducer and the marine electronic device configured to operate to provide real-time marine data from the sonar transducer in a first mode. The marine electronic device is further configured to change to a power-saving mode in which the marine electronic device operates by drawing a reduced amount of power from a power source and does not provide real-time marine data from the sonar transducer. The system also includes a second device, and the second device uses power from a second power source. The marine electronic device includes a display, one or more processors, and a memory including a computer program code configured to, when executed, cause the one or more processors to receive second device real-time marine data from the second device. The second device real-time marine data is gathered or determined via the second device and not the marine electronic device. The memory including the computer program code is also configured to, when executed, cause presentation of a representation of the second device real-time marine data on a screen of the marine electronic device while still operating in the power-saving mode.

In some embodiments, the second device may be connected to a second sonar transducer.

In some embodiments, the second device may operate by drawing an amount of power from the second power source.

In some embodiments, the second device may provide at least a portion of the second device real-time marine data from the second sonar transducer.

In some embodiments, the system may further include a data network.

In some embodiments, the second device real-time marine data may travel through the data network to the marine electronic device.

In some embodiments, causing presentation of the representation of the second device real-time marine data on the screen of the marine electronic device may further include dynamically updating the representation of the second device real-time marine data on the screen of the marine electronic device.

In some embodiments, the representation of the second device real-time marine data may be displayed on the screen of the marine electronic device without increasing the reduced amount of power from the power source past a predetermined threshold.

In some embodiments, the second device may be a second marine electronic device.

In some embodiments, the second device may be a trolling motor.

In some embodiments, the second device real-time marine data may include at least one of depth data, water temperature data, fuel data, weather data, wind data, tide data, sonar data, anchor data, or vessel data.

In some embodiments, the vessel data may include at least one of a vessel length, bow height, a vessel draft, a minimum turn radius, or trim tab data.

In some embodiments, the second device may be located on a bow portion of a watercraft, and the marine electronic device may be located on a middle portion or a stern portion of the watercraft.

In some embodiments, the processor may be further configured to receive user input indicating that the power-saving mode is desired.

In some embodiments, the processor may be further configured to change into the power-saving mode automatically based on a predetermined amount of time having elapsed without user-interaction detected.

In some embodiments, the marine electronic device may be separate from the second device.

In another example embodiment, a method is provided of conserving power on a marine electronic device while conveying information to a user. The method includes determining whether to implement a power-saving mode on a marine electronic device. The marine electronic device is configured to operate to provide real-time marine data from a sonar transducer in a first mode, and the marine electronic device is further configured to change to the power-saving mode in which the marine electronic device operates by drawing a reduced amount of power from a power source and does not provide real-time date from the sonar transducer. The method further includes receiving second device real-time marine data from a second device. The second device real-time marine data is gathered or determined via the second device and not the marine electronic device, and the second device draws power from a second power source. The method further includes displaying a representation of the second device real-time marine data on a screen of the marine electronic device while operating in the power-saving mode.

In some embodiments, the second device may be connected to a second sonar transducer.

In some embodiments, the representation of the second device real-time marine data may be displayed on the screen of the marine electronic device without increasing the reduced amount of power from the power source past a predetermined threshold.

In another example embodiment, a marine electronic device is provided. The marine electronic device includes a display, one or more processors, and a memory including a computer program code configured to, when executed, cause the one or more processors to operate according to a power-saving mode on the marine electronic device. The marine electronic device is configured to operate to provide real-time marine data from a sonar transducer in a first mode, and the marine electronic device is further configured to change to the power-saving mode in which the marine electronic device operates by drawing a reduced amount of power from a power source and does not provide real-time date from the sonar transducer. The memory including the computer program code is also configured to, when executed, receive second device real-time marine data from a second device. The second device real-time marine data is gathered or determined via the second device and not the marine electronic device, and the second device draws power from a second power source. The memory including the computer program code is also configured to, when executed, display a representation of the second device real-time marine data on a screen of the marine electronic device while operating in the power-saving mode.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an example watercraft, in accordance with some embodiments described herein;

FIG. 2 shows an example marine electronic device, in accordance with some embodiments discussed herein;

FIG. 3 shows the marine electronic device of FIG. 2 in a power-saving mode, in accordance with some embodiments discussed herein;

FIG. 4 is a flowchart of an example method for a data network for conserving power on a marine electronic device while conveying information to a user, in accordance with some embodiments discussed herein;

FIG. 5 is a block diagram of an example system, in accordance with some embodiments discussed herein; and

FIG. 6 shows an example method of conserving power on a marine electronic device while conveying information to a user, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

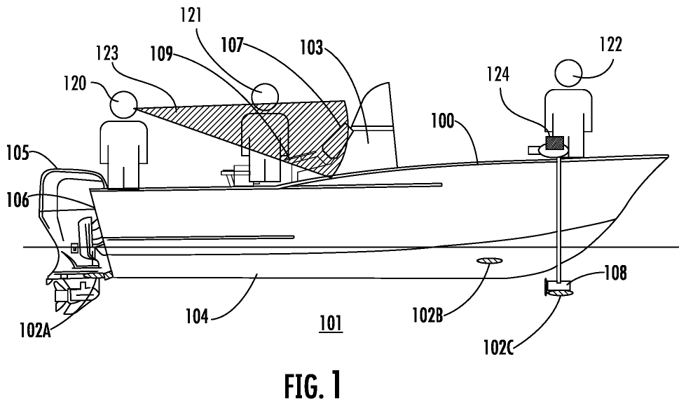

As depicted in FIG. 1, a watercraft 100 (e.g., a vessel) configured to traverse a marine environment, e.g., body of water 101, may have one or more sonar transducers, such as first sonar transducer 102A, second sonar transducer 102B, and third sonar transducer 102C, disposed on and/or proximate to the watercraft. The watercraft 100 may be a surface watercraft, a submersible watercraft, or any other implementation known to those skilled in the art. The one or more sonar transducers may each be configured to send and receive signals in order to image the underwater environment within the body of water 101 beneath the watercraft 100.

Depending on the configuration, the watercraft 100 may include a main propulsion motor 105, such as an outboard or inboard motor. Additionally, the watercraft 100 may include the trolling motor 108 configured to propel the watercraft 100 or maintain a position. The motor 105 and/or the trolling motor 108 may be steerable using the steering wheel 109, or in some embodiments, the watercraft 100 may have an autopilot navigation assembly that is operable to steer the motor 105 and/or the trolling motor 108, when engaged. The autopilot navigation assembly may be connected to or within a marine electronic device such as marine electronic device 107, or it may be located anywhere else on the watercraft 100. Alternatively, it may be located remotely, or in other embodiments, the watercraft 100 may not have an autopilot navigation assembly at all.

The watercraft 100 may also include one or more devices, such as may be utilized by a user to interact with, view, or otherwise control various aspects of the watercraft and its various marine systems described herein. In the illustrated embodiment, the marine electronic device 107 is positioned proximate the helm (e.g., steering wheel) of the watercraft 100—although other places on the watercraft 100 are contemplated. A second device 124, which may or may not be a marine electronic device, is positioned on a handle portion of the trolling motor 108. Likewise, additionally or alternatively, a user's mobile device may include functionality of a marine electronic device. Additional devices may be located at other positions on or near the watercraft, such as at the stern or in a cabin of the watercraft 100.

In the embodiment shown in FIG. 1, the marine electronic device 107 is within eyesight (e.g., field of vision 123) of a first user 120, who is located near the transom 106 of the watercraft 100. The marine electronic device 107 is also within eyesight of a second user 121, who is located at the helm (e.g., the steering wheel 109) of the watercraft 100. A third user 122, who is located at the bow of the watercraft 100, is within eyesight of the second device 124. As an example, the first user 120 is not within eyesight of the second device 124, but the first user 120 is still within eyesight of the marine electronic device 107. In certain activities, users are moving back and forth on the watercraft for long periods of time, and it is often desirable to save power being used by the devices on the watercraft. However, many of these activities, such as fishing, involve urgent and unexpected events that come up, and it can inconvenience a user if certain devices are “asleep” (e.g., have a black, empty screen, and/or screen saver) when one of those urgent and/or unexpected events arises. For example, if the first user 120, the second user 121, and the third user 122 have been fishing for three hours and have not caught anything, the power drawn by the marine electronic device 107 and the second device 124 may be significant in comparison to how useful they have been to the first user 120, the second user 121, and the third user 122 while no fish were biting. However, if a fish bites after three hours and the marine electronic device 107 were to have been “asleep,” the first user 120, the second user 121, and the third user 122 may not have enough information to catch the fish when the moment arises. Along similar lines, perhaps only a limited amount of information is needed during a prolonged period of time (e.g., current depth), but it may be otherwise an unnecessary power drain to fully run the marine electronic device just to get a depth reading.

The marine electronic device 107 shown in FIG. 1 is configured to change from a first mode, in which the marine electronic device 107 provides real-time marine data from, e.g., a sonar transducer such as the sonar transducer 102B, to a power-saving mode. In the power-saving mode, the marine electronic device 107 may provide information obtained from the second device 124 on a screen of the marine electronic device 107 such that the first user 120 and the second user 121 have access to that information even when the marine electronic device 107 has entered into the power-saving mode. When in the power-saving mode, the marine electronic device 107 may no longer receive real-time marine data from, e.g., the sonar transducer 102B, and may alternatively obtain information from another device such as from the second device 124. Notably, in some such example scenarios, the power for the second device (e.g., to obtain and transfer the real-time marine data) may be drawn from a separate power source—thereby allowing the marine electronic device 107 to remain in a power-saving mode. In some cases, the second device (e.g., second device 124) may need to be running anyway—e.g., while fishing, the trolling motor needs to be running anyway to aid in watercraft control. Thus, using the sonar transducer assembly 102C of the trolling motor 108 to provide real-time marine data to the marine electronic device 107 provides a beneficial solution and uses little to no extra power.

In this regard, the marine electronic device 107 may have a processor that is configured to receive second device real-time marine data from the second device 124, and the second device real-time marine data may be gathered or determined via the second device 124 and not the marine electronic device 107. As noted herein, in some embodiments, the second device 124 may use a second amount of power from a second power source and may operate by drawing an amount of power from the second power source. The processor may then cause presentation of a representation of the second device real-time marine data on a screen of the marine electronic device 107 while the marine electronic device 107 is still operating in the power-saving mode. In some embodiments, the marine electronic device 107 may do so without increasing the reduced amount of power being drawn by the marine electronic device 107 from the power source past a predetermined threshold. Further, in some embodiments, the marine electronic device 107 may be configured to dynamically update the representation of the second device real-time marine data on the screen of the marine electronic device 107 over time for as long as the marine electronic device 107 remains in the power-saving mode.

For example, in the first mode, the marine electronic device 107 might be displaying real-time sonar data from the sonar transducer 102B on the screen of the marine electronic device 107. When the marine electronic device 107 transitions into the power-saving mode (e.g., in response to user input indicating as such and/or automatically in response to a detection that a predetermined amount of time has elapsed without user-interactions detected), the marine electronic device 107 might stop displaying the real-time sonar data from the sonar transducer 102B in order to reduce the amount of power being drawn from the power source connected to the marine electronic device 107. The marine electronic device 107 may then receive information such as water temperature and water depth from the second device 124 and display that information on the screen of the marine electronic device 107 so that users on the watercraft 100 are still adequately informed for the duration of the power-saving mode. Continuing the previous example, when a fish bites at the back of the watercraft 100 after three hours, although the marine electronic device 107 may be in the power-saving mode, the first user 120 merely has to glance at the marine electronic device 107 from where he or she is standing to obtain vital information, such as water depth, that he or she needs to successfully reel the fish into the watercraft 100.

The second device real-time marine data that is received by the marine electronic device 107 from the second device 124 may be any type of data. For example, the second device real-time marine data may include depth data, water temperature data, fuel data, weather data, wind data, tide data, sonar data, anchor data, and/or vessel data, among other types of data. In embodiments in which vessel data is included, such vessel data may include vessel length, bow height, a vessel draft, a minimum turn radius, and/or trim tab data, among others. As an example, instead of receiving water temperature and water depth information from the second device 124 and displaying such water temperature and water depth information on the screen of the marine electronic device 107 when the power-saving mode is turned on, the marine electronic device 107 may be configured to receive mapping and contour line information from the second device 124 and display such mapping and contour information on the screen of the marine electronic device 107 when the power-saving mode is turned on. Other types of information are also contemplated within the scope of this disclosure.

As noted above, in some embodiments, such as that shown in FIG. 1, the second device 124 may be connected to the trolling motor 108 and may also be connected to the third sonar transducer 102C. In such cases, the second device 124 may provide at least a portion of the second device real-time marine data from the third sonar transducer 102C. In other embodiments, however, the second device 124 may be anywhere else on or near the watercraft 100 and may be configured differently. For example, the second device 124 may be a mobile device being held or worn by one of the first user 120, the second user 121, or the third user 122, or the second device 124 may be any other type of device. As another example, the second device 124 may be a second marine electronic device. Other examples are also contemplated within the scope of this disclosure.

In some embodiments, the second device 124 may be located on a bow portion of the watercraft 100 in some embodiments, and the marine electronic device 107 may be located on a middle portion of the watercraft 100, such as shown in FIG. 1. In other embodiments, the second device 124 may be located on a stern portion or a middle portion of the watercraft 100, or even on an adjacently positioned watercraft, and the marine electronic device 107 may be located on a stern position or a bow position of the watercraft 100. Further, in some other embodiments, the second device 124 and the marine electronic device 107 may both be located on a bow position, a middle position, or a stern position of the watercraft 100. The second device 124 and the marine electronic device 107 may be separate in some embodiments, such as shown in FIG. 1, but in other embodiments, the second device 124 and the marine electronic device may be part of a same component. Other configurations are also contemplated within the scope of this disclosure.

Although the second device 124 in FIG. 1 is connected to a different power source than the marine electronic device 107, in other embodiments, the second device 124 may be connected to the same power source as the marine electronic device 107. In either scenario, the power-saving mode may be enabled on the marine electronic device 107 to reduce the amount of power being drawn by the marine electronic device 107.

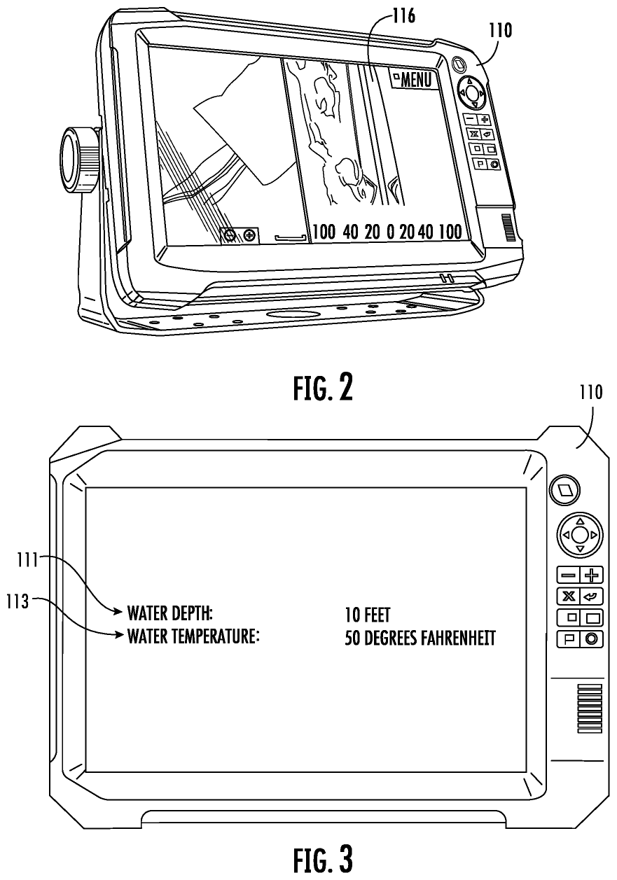

FIG. 2 shows a marine electronic device 110 operating in a first mode (e.g., a non-power saving mode). Real-time sonar data 116 from a sonar transducer, such as the sonar transducer 102B in FIG. 1, is displayed on the screen. The marine electronic device 110 may be located anywhere on or near a watercraft, such as is the marine electronic device 107 in FIG. 1, and sonar data may be pulled from a sonar transducer on or near the watercraft such as the sonar transducer 102B in FIG. 1.

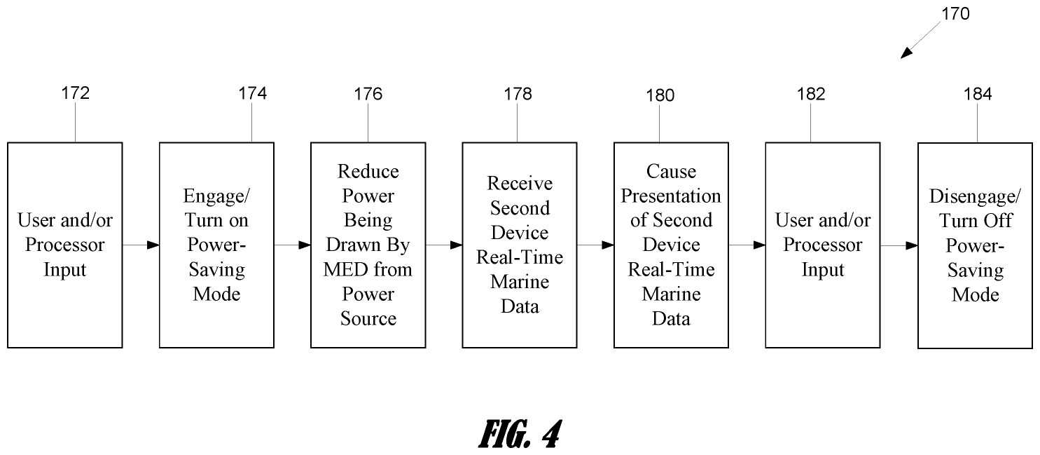

FIG. 3 shows the marine electronic device 110 in a power-saving mode. The marine electronic device 110 is no longer providing real-time marine data from the sonar transducer as it was in FIG. 2, but it is providing second device real-time marine data from a second device and is causing presentation of a representation of the second device real-time marine data on the screen of the marine electronic device 110 while still operating in the power-saving mode. The second device real-time marine data shown in FIG. 3 includes water depth information 111 and water temperature information 113. Notably, the second device real-time marine data is gathered or determined via the second device and not the marine electronic device 110. This enables the marine electronic device 110 to draw a reduced amount of power from its power source while still providing information to the user for viewing. This is especially useful in circumstances in which a user is within eyesight of the marine electronic device 110 but is not within eyesight of the second device, as described herein (or when the second device doesn't have a screen).

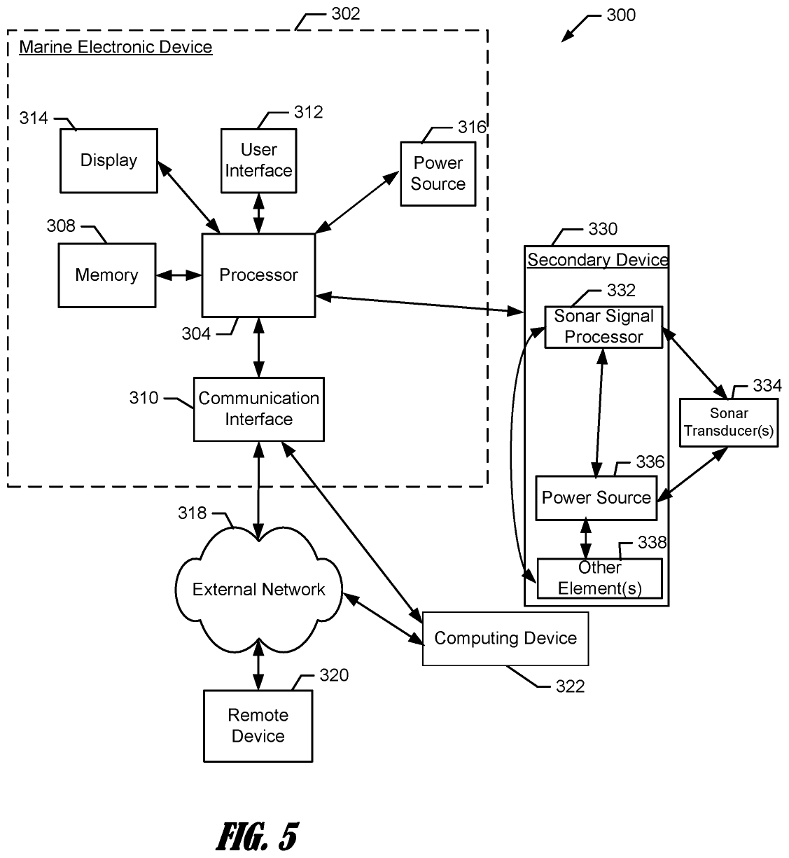

FIG. 4 is a flowchart showing an example method 170 of a data network (or BUS) for conserving power on a marine electronic device while conveying information to a user. In some embodiments, second device real-time marine data may travel through the data network shown in FIG. 4 to the marine electronic device. The method 170 includes, at operation 172, receiving user and/or processor input. The operation 172 may include, for example, receiving information that a user has pressed a button indicating that the user wants to enter power-saving mode or receiving information that no user interaction has occurred within a predetermined timeframe (among other things). The method 170 may then include, at operation 174, engaging and/or turning on power-saving mode. The power-saving mode may, when engaged and/or turned on, operate to cause the marine electronic device to operate by drawing a reduced amount of power from a power source. For example, in the power-saving mode, the marine electronic device may no longer provide real-time marine data from a sonar transducer as it might would while in a first mode, in which a larger amount of power is being drawn from the power source. In some embodiments, operating in power-saving mode may utilize a lesser percentage of power than operating in normal mode (e.g., 10% or less, 5% or less, etc.). At operation 176, the method 170 may include reducing power being drawn by the marine electronic device from the power source. The system may then include at operation 178 receiving second device real-time marine data from a second device, and then at operation 180, the method 170 may include causing presentation of the second device real-time marine data on a display of the marine electronic device. The method 170 may then include receiving user and/or processor input at operation 182 to, e.g., determine whether or not to continue operating in power-saving mode. For example, the processor may detect that no user interaction has occurred since power-saving mode was engaged and may send a signal for the marine electronic device to continue operating in power-saving mode. Alternatively, the processor may detect that user interaction has occurred and therefore send a signal to cause the marine electronic device to return to operating in the first mode. The processor may also send a signal in response to user input indicating that the marine electronic device should continue operating in the power-saving mode or that the marine electronic device should return to operating in the first mode. Other methods are also contemplated, such as the processor detecting a sudden change in acceleration of the watercraft and sending a signal to cause the marine electronic device to return to operating in the first mode. Depending on the input received at operation 182, the method 170 may then disengage and/or turn off the power-saving mode at operation 184.

It should be appreciated that, in some embodiments, the operations within the method shown in FIG. 4 may be executed in any other order. In some other embodiments, certain operations within the method shown in FIG. 4 may be optional or omitted entirely. Further, in some embodiments, the method shown in FIG. 4 may contain additional operations other than those shown.

### Example System Architecture

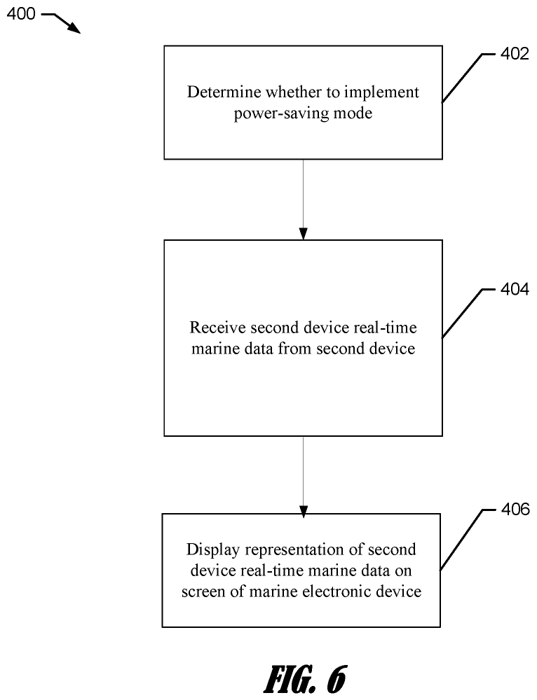

FIG. 5 shows a block diagram of an example system 300 capable for use with several embodiments of the present disclosure. As shown, the system 300 may include a number of different modules or components, each of which may comprise any device or means embodied in either hardware, software, or a combination of hardware and software configured to perform one or more corresponding functions. For example, the system 300 may include a marine electronic device 302 (e.g., controller), a secondary device 330, and various sensors/system.

The marine electronic device 302, controller, remote control, MFD, and/or user interface display may include a processor 304, a memory 308, a communication interface 310, a user interface 312, and a display 314. The processor 304 may be in communication with one or more components such as secondary device 330 and power source 316 to conserve power on the marine electronic device 302 while conveying information to a user. For example, the processor 304 may be in communication with the secondary device 330 via a BUS or data network such that the processor can receive information from the secondary device 330 and display it on the display 314 of the marine electronic device 302 when the marine electronic device 302 is in power-saving mode.

The secondary device 330 may optionally include a sonar signal processor 332, a power source 336, and/or other element(s) 338, and the secondary device 330 may be in communication with the processor 304 of the marine electronic device 302. Further, the secondary device 330 may be in communication with one or more sonar transducer(s) 334, as described herein. The one or more sonar transducer(s) 334 may be in communication with the sonar signal processor 332 and/or the power source 336, or the one or more sonar transducer(s) 334 may be connected to a different processor and/or power source.

In some embodiments, the system 300 may be configured to receive, process, and display various types of marine data. In some embodiments, the system 300 may include one or more processors 304 and the memory 308. Additionally, the system 300 may include one or more components that are configured to gather marine data or perform marine features. In such a regard, the processor 304 may be configured to process the marine data for various functionality described herein. Further, the system 300 may be configured to communicate with various internal or external components (e.g., through the communication interface 310), such as to provide instructions related to the marine data.

The processor 304 may be any means configured to execute various programmed operations or instructions stored in a memory, such as a device and/or circuitry operating in accordance with software or otherwise embodied in hardware or a combination thereof (e.g., a processor operating under software control, a processor embodied as an application specific integrated circuit (ASIC) or field programmable gate array (FPGA) specifically configured to perform the operations described herein, or a combination thereof) thereby configuring the device or circuitry to perform the corresponding functions of the processor 304 as described herein. In this regard, the processor 304 may be configured to analyze electrical signals communicated thereto.

The memory 308 may be configured to store instructions, computer program code, marine data, and/or other data associated with the system 300 in a non-transitory computer readable medium for use by the processor, for example.

The system 300 may also include one or more communications modules configured to communicate via any of many known manners, such as via a network, for example. The processing circuitry and communication interface 310 may form a processing circuitry/communication interface. The communication interface 310 may be configured to enable connections to external systems (e.g., an external network 318 or one or more remote controls, such as a handheld remote control, marine electronics device, foot pedal, or other remote computing device). In this regard, the communication interface (e.g., 310) may include one or more of a plurality of different communication backbones or frameworks, such as Ethernet, USB, CAN, NMEA 2000, GPS, Sonar, cellular, WiFi, and/or other suitable networks, for example. In this manner, the processor 304 may retrieve stored data from a remote, external server via the external network 318 in addition to or as an alternative to the onboard memory 308. The network may also support other data sources, including GPS, autopilot, engine data, compass, radar, etc. Numerous other peripheral, remote devices such as one or more wired or wireless multi-function displays may be connected to the system 300.

The processor 304 may configure the device and/or circuitry to perform the corresponding functions of the processor 304 as described herein. In this regard, the processor 304 may be configured to analyze electrical signals communicated thereto to provide, for example, various features/functions described herein.

The display 314 may be configured to display images and may include or otherwise be in communication with a user interface 312 configured to receive input from a user. The display 314 may be, for example, a conventional liquid crystal display (LCD), LED/OLED display, touchscreen display, mobile media device, and/or any other suitable display known in the art, upon which images may be displayed. In some embodiments, the display 314 may be the MED and/or the user's mobile media device. The display may be integrated into the marine electronic device 302. In some example embodiments, additional displays may also be included, such as a touch screen display, mobile media device, or any other suitable display known in the art upon which images may be displayed.

In some embodiments, the display 314 and/or user interface 312 may be a screen that is configured to merely present images and not receive user input. In other embodiments, the display and/or user interface may be a user interface such that it is configured to receive user input in some form. For example, the screen may be a touchscreen that enables touch input from a user. Additionally, or alternatively, the user interface may include one or more buttons (not shown) that enable user input. For example, the display 314 and/or user interface 312 may include buttons that allow the user to cause the marine electronic device 302 to go into a power-saving mode.

The user interface 312 may include, for example, a keyboard, keypad, function keys, mouse, scrolling device, input/output ports, touch screen, or any other mechanism by which a user may interface with the system.

In some embodiments, the system 300 further includes a power source 316 (e.g., battery) that is configured to provide power to the various components of the marine electronic device 302. In some embodiments, the power source 316 is rechargeable. In some example embodiments, the system 300 includes a battery sensor. The battery sensor may include a current sensor or voltage sensor configured to measure the current charge of a battery power supply of the system 300 (e.g., the power source 316). The battery sensor may be configured to measure individual battery cells or measure a battery bank. The processor 304 may receive battery data from the battery sensor and determine the remaining charge on the battery. In an example embodiment, the voltage or current measured by the battery sensor may be compared to a reference value or data table, stored in memory 308, to determine the remaining charge on the battery. The battery sensor may also, in some embodiments, be configured to detect an amount of power being drawn by the marine electronic device 302 from the power source 316 then may communicate that amount to the processor 304 to determine whether to cause the marine electronic device 302 to enter into the power-saving mode.

In some embodiments, the secondary device 330 may have a separate power source 336 that is similar to the power source 316 described above. For example, the power source 336 may be configured to provide power to the various components of the secondary device 330 and/or the one or more sonar transducer(s) 334. In some embodiments, the power source 336 may be rechargeable. In some example embodiments, the secondary device 330 may include a battery sensor. The battery sensor may include a current sensor or voltage sensor configured to measure the current charge of a battery power supply of the power source 336. The battery sensor may be configured to measure individual battery cells or measure a battery bank. The processor 304 and/or sonar signal processor 332 may receive battery data from the battery sensor and determine the remaining charge on the battery. In an example embodiment, the voltage or current measured by the battery sensor may be compared to a reference value or data table, stored in memory, to determine the remaining charge on the battery. In other embodiments, the secondary device 330 may not have the power source 336 and may instead be connected to the power source 316.

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in general context of computer-executable instructions, such as program modules, being executed by a computer. Generally, program modules may include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some instances, program modules may be implemented on separate computing systems and/or devices adapted to communicate with one another. Further, a program module may be some combination of hardware and software where particular tasks performed by the program module may be done either through hardware, software, or both.

The various technologies described herein may be implemented in the context of marine electronics, such as devices found in watercrafts and/or navigation systems. Ship instruments and equipment may be connected to the computing systems described herein for executing one or more navigation technologies. As such, the computing systems may be configured to operate using sonar, radar, GPS and like technologies.

The various technologies described herein may also be implemented in distributed computing environments where tasks are performed by remote processing devices that are linked through a communications network (e.g., by hardwired links, wireless links, or combinations thereof). In a distributed computing environment, program modules may be located in both local and remote computer storage media including memory storage devices.

The system 300 may include a computing device or system (e.g., mobile media device) into which implementations of various technologies and techniques described herein may be implemented. Computing device 322 may be a conventional desktop, a handheld device, a wearable device, a controller, a personal digital assistant, a server computer, an electronic device/instrument, a laptop, a tablet, or part of a navigation system, marine electronics, or sonar system. It should be noted, however, that other computer system configurations may be used.

In various implementations, each marine electronic device 302 described herein may be referred to as a marine device or as an MFD. The marine electronic device 302 may include one or more components disposed at various locations on a watercraft. Such components may include one or more data modules, sensors, instrumentation, and/or any other devices known to those skilled in the art that may transmit various types of data to the marine electronic device 302 for processing and/or display. The various types of data transmitted to the marine electronic device 302 may include marine electronics data and/or other data types known to those skilled in the art. The marine data received via the marine electronic device 302 or other components of the system 300 may include chart data, sonar data, structure data, radar data, navigation data, position data, heading data, automatic identification system (AIS) data, Doppler data, speed data, course data, or any other type known to those skilled in the art.

The marine electronic device 302 may receive external data via a LAN or a WAN. In some implementations, external data may relate to information not available from various marine electronics systems. The external data may be retrieved from various sources, such as, e.g., the Internet or any other source. The external data may include atmospheric temperature, atmospheric pressure, tidal data, weather, temperature, moon phase, sunrise, sunset, water levels, historic fishing data, and/or various other fishing and/or trolling related data and information.

The marine electronic device 302 may be attached to various buses and/or networks, such as a National Marine Electronics Association (NMEA) bus or network, for example. The marine electronic device 302 may send or receive data to or from another device attached to the NMEA 2000 bus. For instance, the marine electronic device 302 may transmit commands and receive data from a motor or a sensor using an NMEA 2000 bus. In some implementations, the marine electronic device 302 may be capable of steering a watercraft and controlling the speed of the watercraft (e.g., autopilot). For instance, one or more waypoints may be input to the marine electronic device 302, and the marine electronic device 302 may be configured to steer the watercraft to the one or more waypoints. Further, the marine electronic device 302 may be configured to transmit and/or receive NMEA 2000 compliant messages, messages in a proprietary format that do not interfere with NMEA 2000 compliant messages or devices, and/or messages in any other format. In various other implementations, the marine electronic device 302 may be attached to various other communication buses and/or networks configured to use various other types of protocols that may be accessed via, e.g., NMEA 2000, NMEA 0183, Ethernet, Proprietary wired protocol, etc. In some implementations, the marine electronic device 302 may communicate with various other devices on the watercraft via wireless communication channels and/or protocols.

In some implementations, the marine electronic device 302 may be connected to a global positioning system (GPS) receiver and/or any other sensors such as motion sensors, magnetometers, attitude sensors, etc. The marine electronic device 302 and/or the GPS receiver and other sensors may be connected via a network interface. In this instance, the GPS receiver and other sensors may be used to determine position and coordinate data for a watercraft on which the marine electronic device 302 is disposed. In some instances, the GPS receiver and other sensors may transmit position coordinate data to the marine electronic device 302. In various other instances, any type of known positioning system may be used to determine and/or provide position coordinate data to/for the marine electronic device 302.

In some embodiments, the marine electronic device 302 may be configured as a computing system similar to computing device 322.

### Example Flowchart

Embodiments of the present disclosure provide methods for conserving power on a marine electronic device while conveying information to a user. Various examples of the operations performed in accordance with embodiments of the present disclosure will now be provided with reference to FIG. 6.

FIG. 6 illustrates a flowchart according to an example method 400 for conserving power on a marine electronic device while conveying information to a user according to various example embodiments described herein. The operations illustrated in and described with respect to FIG. 6 may, for example, be performed by, with the assistance of, and/or under the control of one or more of the processor 304, memory 308, communication interface 310, user interface 312, display 314, secondary device 330, sonar transducer(s) 334, sonar signal processor 332, power source 336, other element(s) 338, power source 316, computing device 322, remote device 320, and/or other components described herein.

Operation 402 may comprise determining whether to implement a power-saving mode. The marine electronic device may be configured to operate to provide real-time marine data from a sonar transducer in a first mode, and the marine electronic device may be further configured to be able to change to the power-saving mode in which the marine electronic device operates by drawing a reduced amount of power from a power source and does not provide real-time date from the sonar transducer. For example, in some embodiments, operation 402 may include determining whether a certain amount of user interaction has occurred within a past predetermined amount of time and/or receiving user input indicating that the user desires for the marine electronic device to enter into the power-saving mode. In some other embodiments, operation 402 may additionally or alternatively include any other method of determination. The processor 304, marine electronic device 302, display 314, and/or computing device 322 may, for example, provide means for performing operation 402.

Operation 404 may comprise receiving second device real-time marine data from a second device. The second device real-time marine data may be gathered or determined via the second device and not the marine electronic device. In some embodiments, the second device may be connected to a second sonar transducer, and the second device may operate by drawing an amount of power from a second power source. Further, in some example embodiments, the second device may provide at least a portion of the second device real-time marine data from the second sonar transducer. The processor 304, marine electronic device 302, display 314, and/or computing device 322 may, for example, provide means for performing operation 404.

Operation 406 may comprise displaying a representation of the second device real- time marine data on a screen of the marine electronic device while operating in the power-saving mode. For example, operation 406 may involve displaying information such as water temperature or water depth on the screen of the marine electronic device, and such information may be obtained from the second device. In some embodiments, other information may be displayed such as fuel data, weather data, wind data, tide data, sonar data, anchor data, and/or vessel data. Other types of data are also contemplated within the scope of this disclosure. The processor 304, marine electronic device 302, display 314, and/or computing device 322 may, for example, provide means for performing operation 406.

FIG. 6 illustrates a flowchart of a system, method, and/or computer program product according to an example embodiment. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 250 and executed by, for example, the processor 248 or controller. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

In some embodiments, the method for conserving power on the marine electronic device while conveying information to the user may include additional, optional operations, and/or the operations described above may be modified or augmented.

### Conclusion

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for conserving power on a marine electronic device while conveying information to a user, the system comprising:
a sonar transducer;
the marine electronic device configured to operate to provide real-time marine data from the sonar transducer in a first mode, wherein the marine electronic device is further configured to change to a power-saving mode in which the marine electronic device operates by drawing a reduced amount of power from a power source and does not provide real-time marine data from the sonar transducer, and
a second device, wherein the second device uses power from a second power source;
wherein the marine electronic device comprises:
a display;
one or more processors; and
a memory including a computer program code configured to, when executed, cause the one or more processors to:
receive second device real-time marine data from the second device, wherein the second device real-time marine data is gathered or determined via the second device and not the marine electronic device; and
cause presentation of a representation of the second device real-time marine data on a screen of the marine electronic device while still operating in the power-saving mode.

2. The system of claim 1, wherein the second device is connected to a second sonar transducer.

3. The system of claim 2, wherein the second device operates by drawing an amount of power from the second power source.

4. The system of claim 3, wherein the second device provides at least a portion of the second device real-time marine data from the second sonar transducer.

5. The system of claim 1, wherein the system further comprises a data network.

6. The system of claim 5, wherein the second device real-time marine data travels through the data network to the marine electronic device.

7. The system of claim 1, wherein causing presentation of the representation of the second device real-time marine data on the screen of the marine electronic device further includes dynamically updating the representation of the second device real-time marine data on the screen of the marine electronic device.

8. The system of claim 1, wherein the representation of the second device real-time marine data is displayed on the screen of the marine electronic device without increasing the reduced amount of power from the power source past a predetermined threshold.

9. The system of claim 1, wherein the second device is a second marine electronic device.

10. The system of claim 1, wherein the second device is a trolling motor.

11. The system of claim 1, wherein the second device real-time marine data includes at least one of depth data, water temperature data, fuel data, weather data, wind data, tide data, sonar data, anchor data, or vessel data.

12. The system of claim 11, wherein the vessel data includes at least one of a vessel length, bow height, a vessel draft, a minimum turn radius, or trim tab data.

13. The system of claim 1, wherein the second device is located on a bow portion of a watercraft, and wherein the marine electronic device is located on a middle portion or a stern portion of the watercraft.

14. The system of claim 1, wherein the processor is further configured to receive user input indicating that the power-saving mode is desired.

15. The system of claim 1, wherein the processor is further configured to change into the power-saving mode automatically based on a predetermined amount of time having elapsed without user-interaction detected.

16. The system of claim 1, wherein the marine electronic device is separate from the second device.

17. A method of conserving power on a marine electronic device while conveying information to a user, the method comprising:
determining whether to implement a power-saving mode on a marine electronic device, wherein the marine electronic device is configured to operate to provide real-time marine data from a sonar transducer in a first mode, and wherein the marine electronic device is further configured to change to the power-saving mode in which the marine electronic device operates by drawing a reduced amount of power from a power source and does not provide real-time date from the sonar transducer;
receiving second device real-time marine data from a second device, wherein the second device real-time marine data is gathered or determined via the second device and not the marine electronic device, wherein the second device draws power from a second power source; and
displaying a representation of the second device real-time marine data on a screen of the marine electronic device while operating in the power-saving mode.

18. The method of claim 17, wherein the second device is connected to a second sonar transducer.

19. The method of claim 17, wherein the representation of the second device real-time marine data is displayed on the screen of the marine electronic device without increasing the reduced amount of power from the power source past a predetermined threshold.

20. A marine electronic device comprising:
a display;
one or more processors; and
a memory including a computer program code configured to, when executed, cause the one or more processors to:
operate according to a power-saving mode on the marine electronic device,
wherein the marine electronic device is configured to operate to provide real-time marine data from a sonar transducer in a first mode, and
wherein the marine electronic device is further configured to change to the power-saving mode in which the marine electronic device operates by drawing a reduced amount of power from a power source and does not provide real-time date from the sonar transducer;
receive second device real-time marine data from a second device, wherein the second device real-time marine data is gathered or determined via the second device and not the marine electronic device, wherein the second device draws power from a second power source; and
display a representation of the second device real-time marine data on a screen of the marine electronic device while operating in the power-saving mode.
